(19) United States
(12) Patent Application Publication
(10) Pub. No.: US 2015/0028604 A1
(43) Pub. Date: Jan. 29, 2015

(54) T-POST GATE KEEPER

(71) Applicant: Mark Lankford, Tyler, TX (US)

(72) Inventor: Mark Lankford, Tyler, TX (US)

(21) Appl. No.: 13/948,601

(22) Filed: Jul. 23, 2013

(51) Int. Cl. E05B 15/02; E05B 65/00

(52) U.S. Cl. CPC E05B 15/024; E05B 65/0007
USPC 292/341.19

(57) ABSTRACT

A gate keeper is provided for attachment of a gate latch to a T-post. In an embodiment, a gate keeper comprises a connector and a gate latch. The gate latch is constructed of a rigid length of material having a latching region, a base region, an extending region, and a u-shaped region. The latching region extends approximately perpendicular to the base region in a first plane. The base region extends approximately perpendicular to the extending region in the first plane. The extending region extends approximately perpendicular with the u-shaped region in a second plane. The connector circumposes the T-post, between a pair of studs. The height of the connector is adjusted by arrangement of the connector between differing pair of studs along the T-post. The gate latch axially rotates about the base region, allowing the u-shaped region to secure a gate rail attached to a movable gate.

### BACKGROUND

The present invention relates to connectors attached to post members, and more particularly to a gate latch assembly connected to a studded T-post.

T-posts have generally been available as fence posts, signs posts, or to fence in areas of land. Studded T-posts have a T-shaped cross-section, with one or more studs spaced along an outer surface of the T-post. The studs attached to the T-posts allow wire or other surfaces to be attached to the T-posts and prevent such wire or surfaces from slipping from the T-post. The uniform spacing of the studs allows the attachments to be attached to such T-posts at various heights relative to the ground.

Some assemblies are known to the art which permit height adjustment by seating on a stud of the T-post. For example, U.S. Pat. No. 5,518,333 pertains to a connector for a studded T-post having an internal connector.

U.S. Pat. No. 6,619,627 discloses a fence bracket for mounting a variety of items by use of u-hooks, plates or brackets to a T-post without the use of tools.

However, the above references suffer from one or more disadvantages. The references either require insertion and removal of an internal connector or other attachment (such as a pin, a plastic tie, nuts and bolts, etc . . . ) for height adjustment along the T-Post or do not provide an adequate gate latching system. Accordingly, a need exists for securing a freely rotating gate latch to a T-post by a height-adjustable connector.

### SUMMARY

In accordance with embodiments of the current invention, a gate keeper is provided for attachment of a gate latch to a T-post. The gate latch is secured to the T-post by a connector, and is capable of rotation with respect to the connector. The gate latch secures a gate rail attached to a movable gate. Rotation of the gate latch with respect to the connector allows the gate latch to secure differing sizes of gate rails. The connector fits between studs of the T-post. Changing the position of the connector between differing studs allows for height adjustment of the T-post gate keeper with respect to the ground.

In a first embodiment, a gate keeper comprises a connector and a gate latch. The gate latch is constructed of a rigid length of material having a latching region, a base region, an extending region, and a u-shaped region. The latching region extends approximately perpendicular to the base region in a first plane. The base region extends approximately perpendicular to the extending region in the first plane. The extending region extends approximately perpendicular with the u-shaped region in a second plane. The connector in the embodiment comprises a first and second spring. One end of each spring attaches to either end of the base region. An opposing end of each spring are attached to each other circumposing the T-post, between a pair of studs. The height of the connector is adjusted by pulling on the springs such that they have enough slack to move in between a different pair of studs along the T-post, thereby allowing adjustment without removal or re-insertion of an external piece. The gate latch is secured against the T-post at the base region and rests between two studs of the T-post. The gate latch axially rotates about the base region, allowing the u-shaped region to secure a gate rail attached to a movable gate.

In a second embodiment, the gate latch is similar to that of the first embodiment. The connector is a square shaped bracket piece, with a pair of external apertures along a front surface of the connector. The connector is inserted over the T-post at a specific height. The gate latch is inserted through the apertures, securing the connector between a pair of studs. The gate latch is capable of axial rotation with respect to the connector.

### BRIEF DESCRIPTION OF THE DRAWINGS

A complete understanding of the present invention may be obtained by reference to the accompanying drawings, when considered in conjunction with the subsequent, detailed description, in which:

FIG. 1 shows a perspective view of a gate keeper illustrating the gate latch securing a gate, according to an embodiment of the invention.

FIG. 2 shows a perspective view of a gate keeper illustrating a gate latch attached to a connector, according to the embodiment of FIG. 1.

FIG. 3 shows a front view of the gate keeper of the embodiment of FIG. 1.

FIG. 4 shows a back view of the gate keeper of the embodiment of FIG. 1.

FIG. 5 shows a side view of the gate keeper of the embodiment of FIG. 1.

FIG. 6 shows a rear perspective view of the gate keeper of the embodiment of FIG. 1.

FIG. 7 shows a top view of the gate keeper of the embodiment of FIG. 1.

FIG. 8 shows a front perspective view illustrating the connector attached to a T-post by a pair of springs, according to the embodiment of FIG. 1.

FIG. 9 shows a rear perspective view illustrating the connector attached to a T-post by a pair of springs, according to the embodiment of FIG. 1.

FIG. 10 shows a top view of the gate latch of the embodiment of FIG. 1.

FIG. 11 shows a side view of the gate latch of the embodiment of FIG. 1.

FIG. 12 shows a perspective view of a gate keeper illustrating the gate latch securing a gate, according to an alternate embodiment of the invention.

FIG. 13 shows a top view of the gate keeper, according to the embodiment of FIG. 12.

FIG. 14 shows a front view of the gate keeper of the embodiment of FIG. 12.

FIG. 15 shows a front perspective view of the gate keeper of the embodiment of FIG. 12.

FIG. 16 shows a top view of the gate latch of the embodiment of FIG. 12.

FIG. 17 shows a side view of the gate latch of the embodiment of FIG. 12.

### DETAILED DESCRIPTION

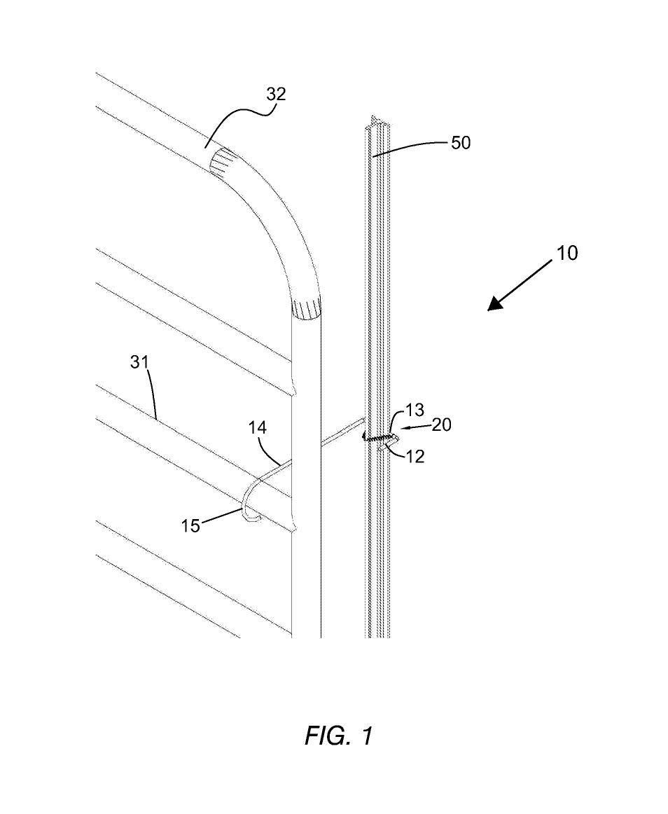

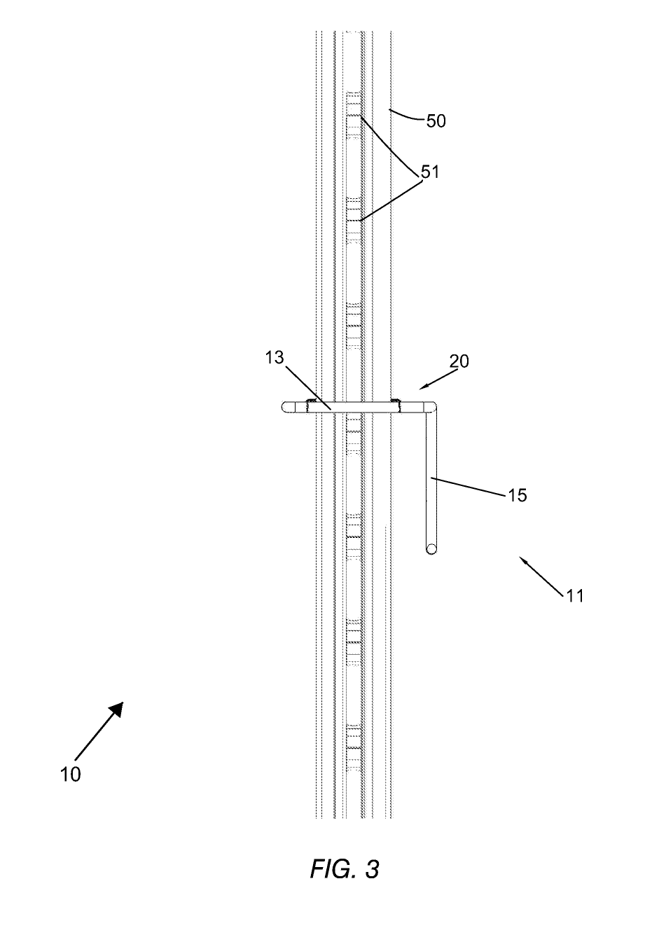

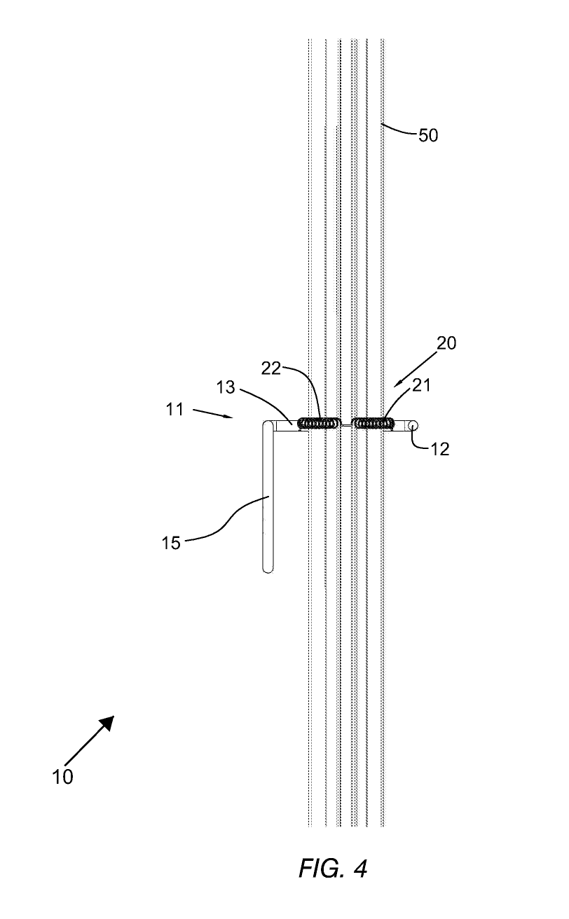

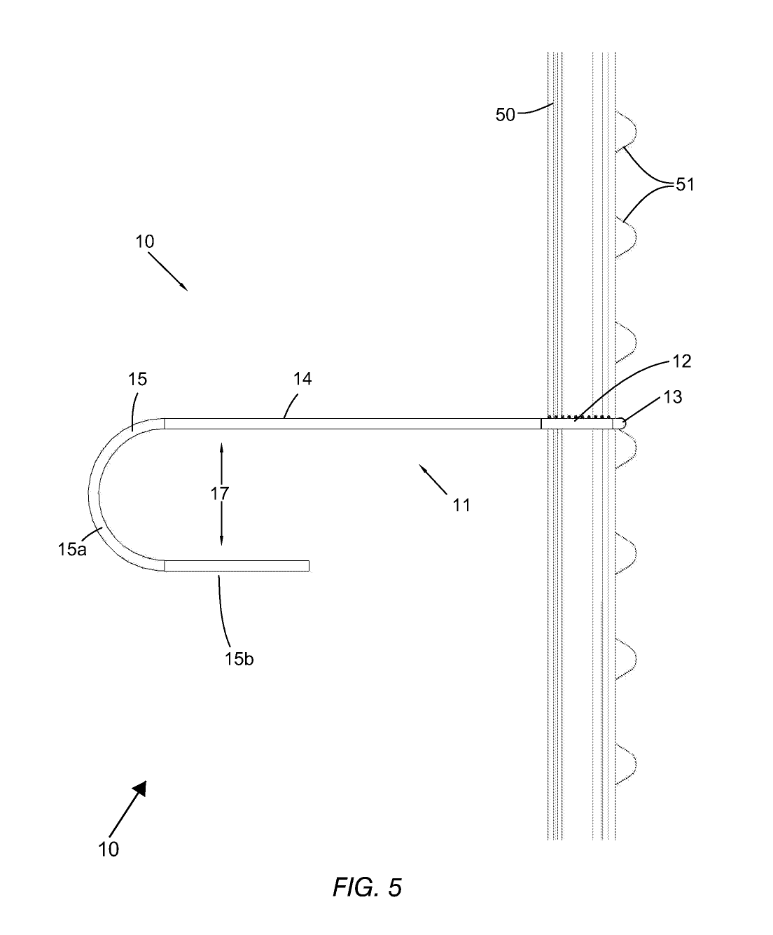

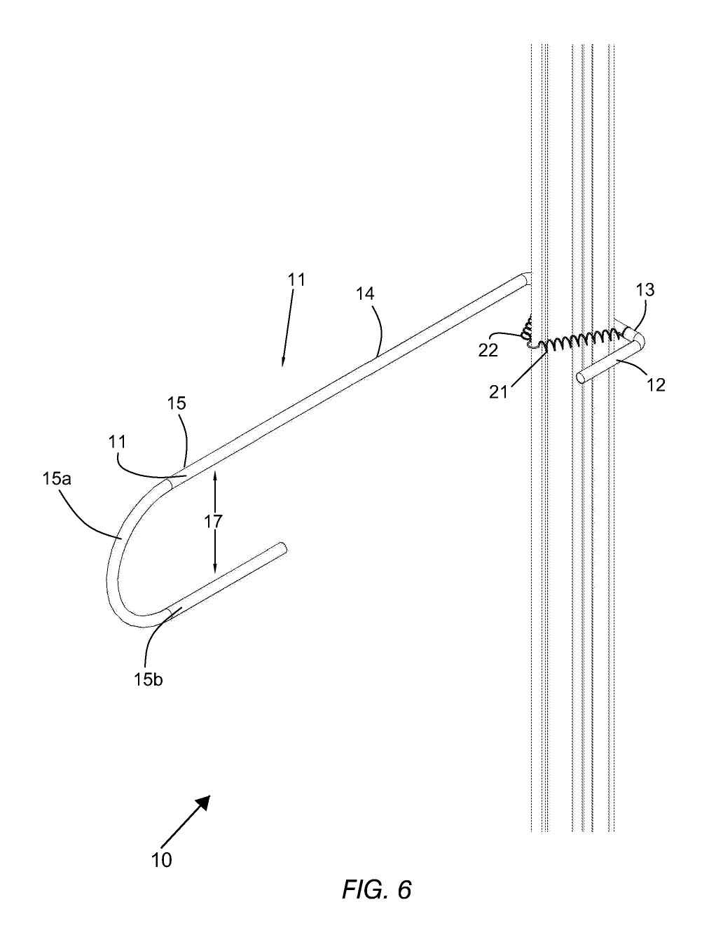

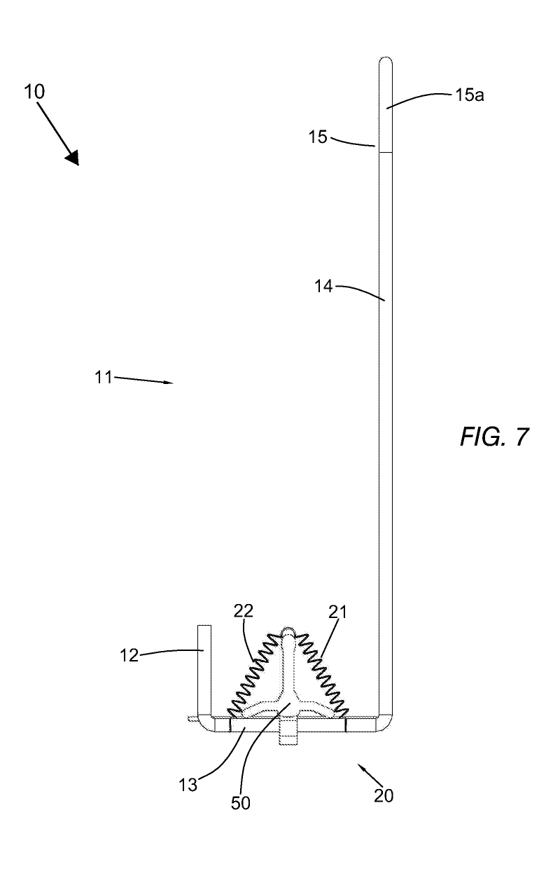

According to an exemplary preferred embodiment of the invention, a gate keeper 10 comprises a gate latch 11 and a connector 20, as shown in FIGS. 1-11. The gate latch 11 is constructed of a rigid piece of elongate metal bent such that the gate latch 11 has a latching region 12, a base region 13, an extending region 14, and a u-shaped region 15.

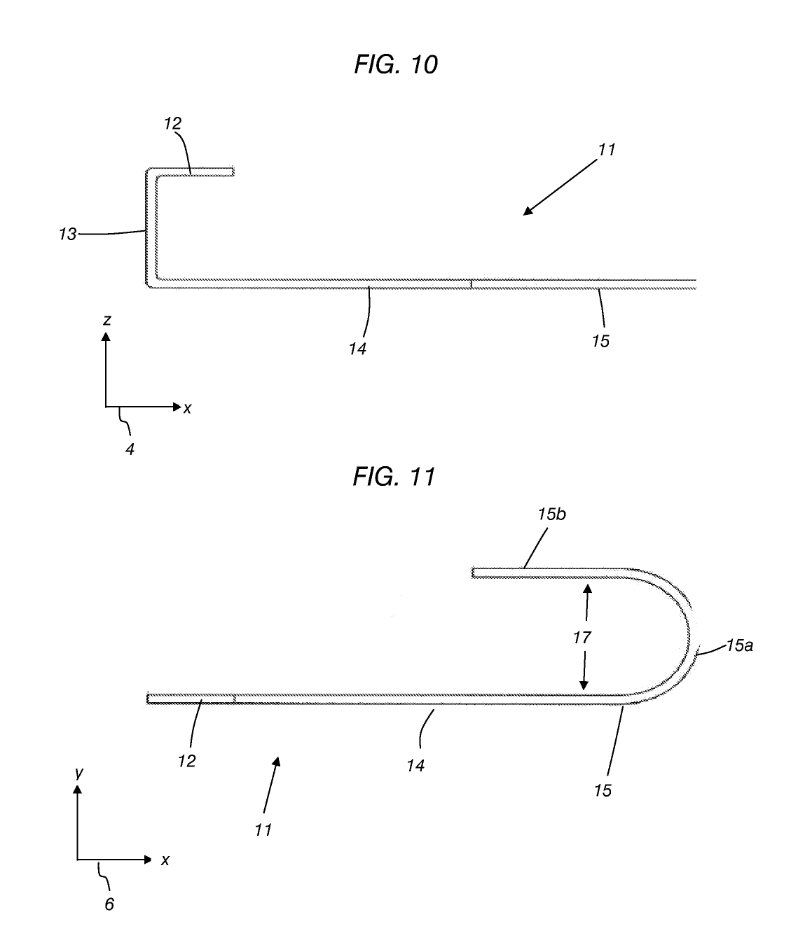

In accordance with FIG. 10, the latch region 12, base region 13, and extending region extend complanar in a first plane 4. The latching region 12 extends approximately 90° to the base region 13, as shown in FIG. 10. The base region 13 extends approximately 90° to the extending region 14, as shown in FIG. 10.

In accordance with FIG. 11, the u-shaped region 15 extends in a second plane 6. The extending region 14 extends approximately 90° to the u-shaped region 15, as shown in FIG. 11. The u-shaped region has a curvilinear surface 15a extending into a lengthwise surface 15b. The lengthwise surface 15b extends approximately parallel with the extending region 14 at a distance 17 which is approximately greater than a diameter of a gate rail 32 attached to a gate 31.

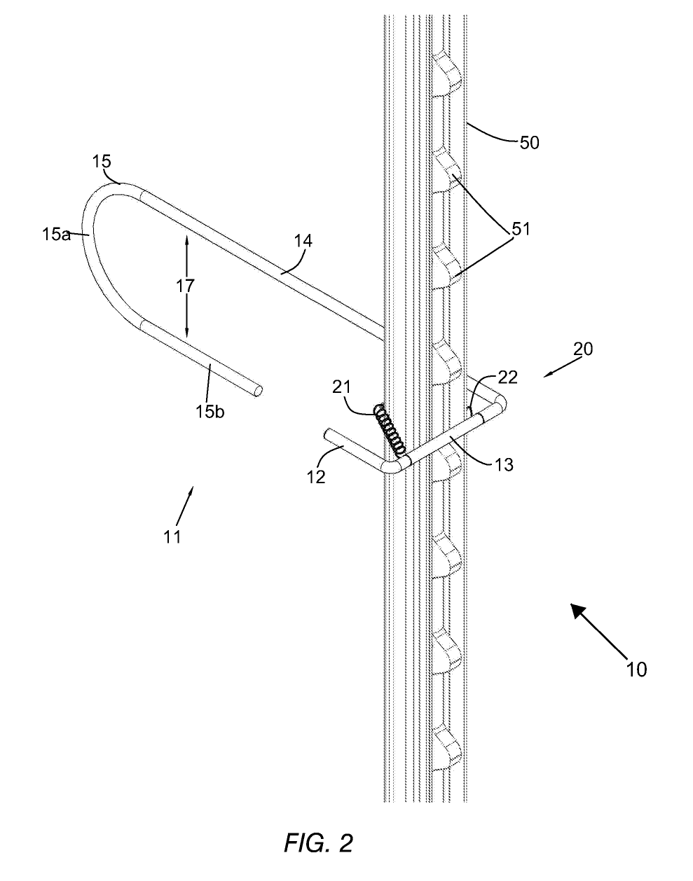

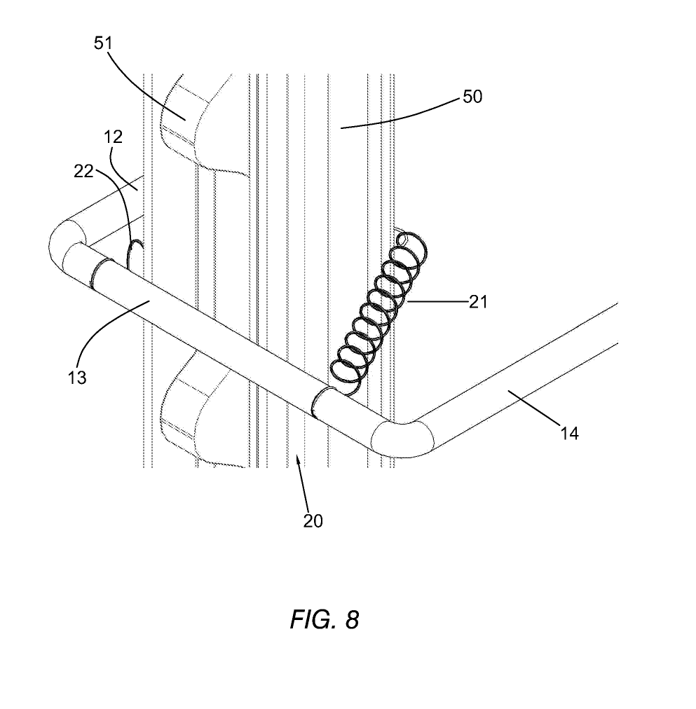

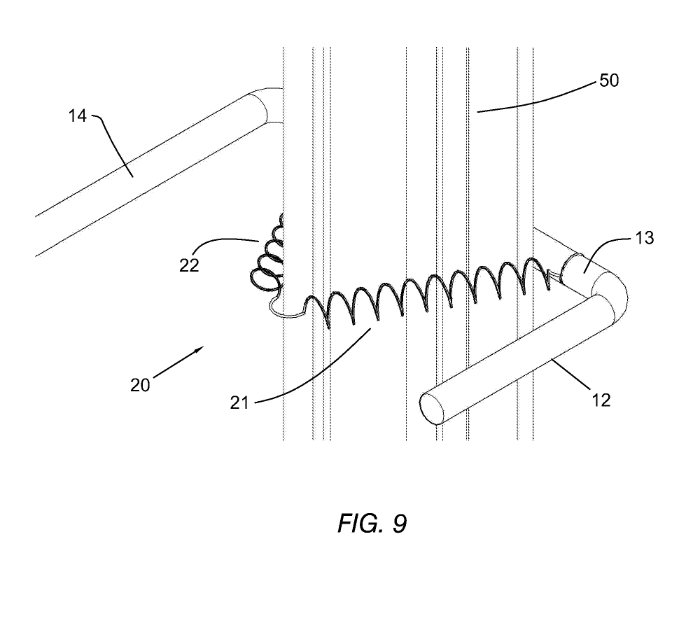

In accordance with FIGS. 2-9, the connector 20 in the embodiment further comprises a first and second spring, 21, 22. One end of each spring 21, 22 attaches to either end of the base region 13. An opposing end of each spring 21, 22 attaches to each other. The springs 21, 22 are arranged such that they circumpose a T-post 50, between a pair of studs 51, as shown in FIGS. 8-9. The height of the connector 20 is adjusted by decompressing on the springs 21, 22 allowing movement of the connector 20 in between a different pair of studs 51 along the T-post 50.

In accordance with FIG. 2, the gate latch 11 is secured against the T-post 50 at the base region 13 and rests between two studs 51 of the T-post 50. The gate latch 11 axially rotates about the base region 13, allowing the u-shaped 15 region to secure the gate rail 32, which is attached to the gate 31.

During operation, the height of the gate keeper 10 can be adjusted by adjusting the springs 21, 22 and moving the connector 20 and gate latch 11 in between differing studs 51 of the T-post 50. In an unlatched position, the gate latch 11 is axially rotated away from the gate rail 32. To secure the gate 31, then the gate latch 11 is axially rotated towards the gate rail 32, allowing the u-shaped region 15 to fit around the gate post 32 to a latched position. The advantage to the embodiment is that the height of the connector 20 can be adjusted by decompression of the springs 21, 22 around the studs 51 and T-post without having to remove the gate latch 11 from the connector 20.

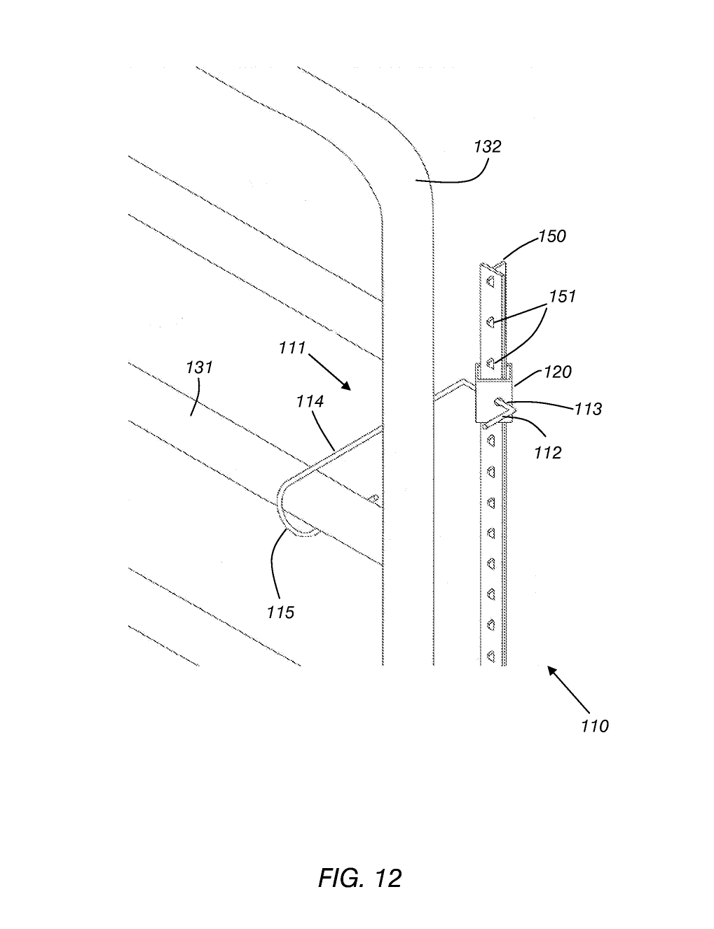

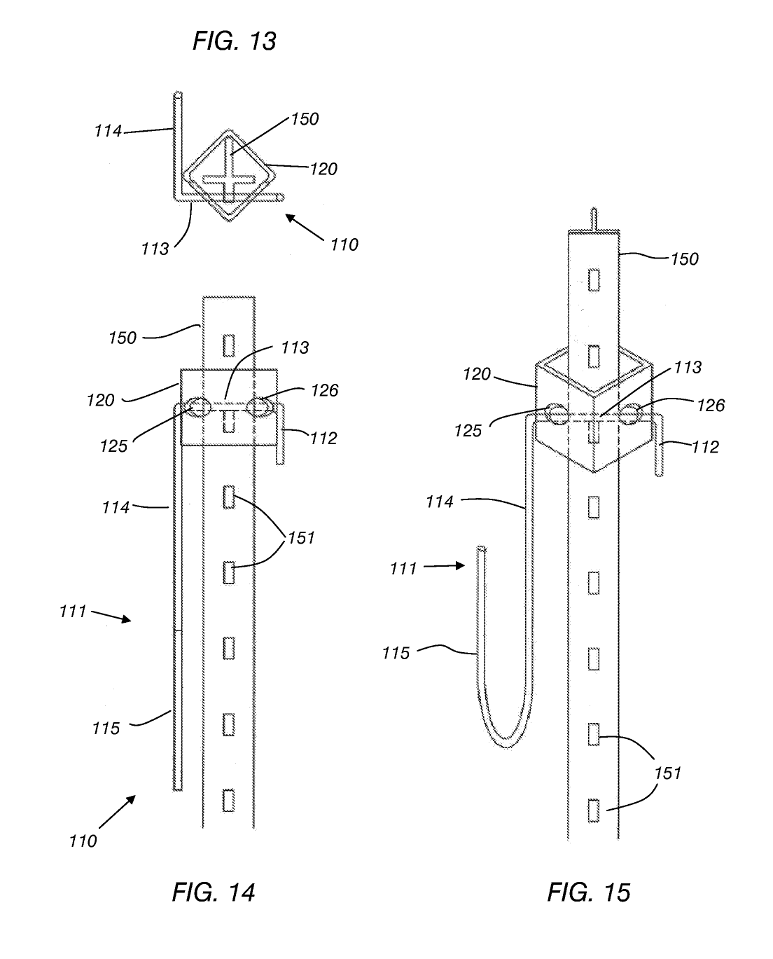

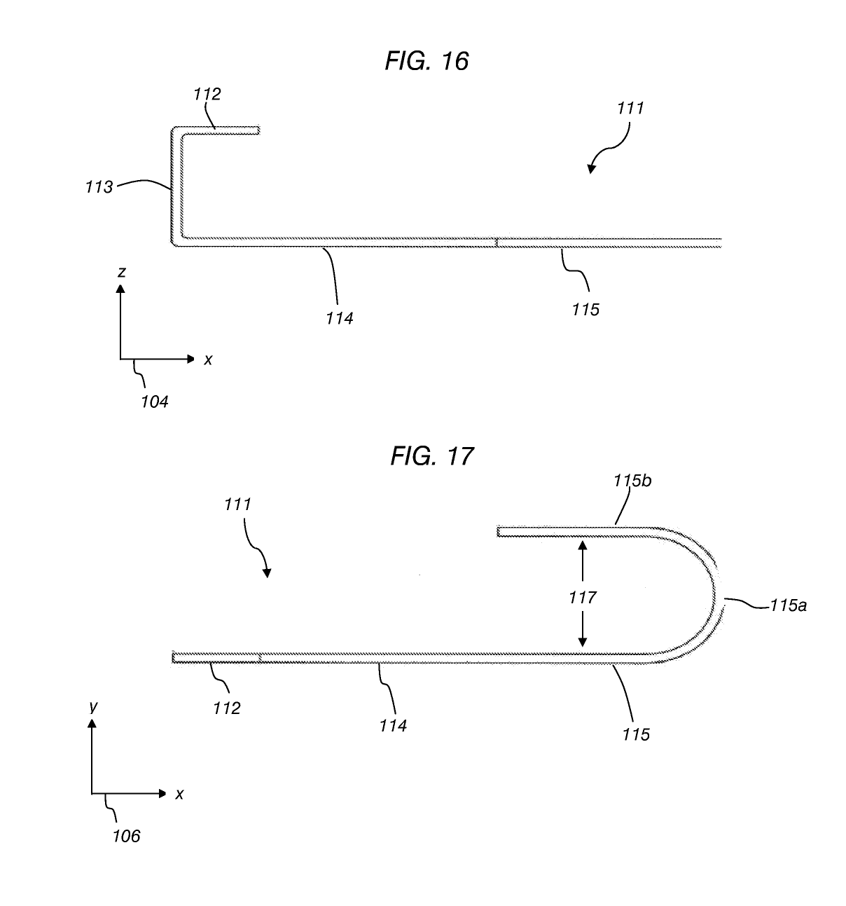

A second embodiment is set forth in accordance with FIGS. 12-17. In the embodiment a gate keeper 110 comprises a gate latch 111 and connector 120. The gate latch 111 of the embodiment is similar to that of the first embodiment and comprises a latching region 112, a base region 113, an extending region 114 existing coplanar in a first plane 104, and a u-shaped region 115 extending in a second plane 106, as shown in FIGS. 16-17. The connector 120 is a square shaped bracket piece, with a pair of external apertures 125, 126 along a front surface of the connector 120, as shown in FIGS. 16-17. The connector 120 is inserted over a T-post 150 at a specific height from the ground. The gate latch 111 is inserted through the apertures 125, 126 as shown in FIGS. 13-15. Insertion of the gate latch 111 through the apertures 125, 126 secures the connector 120 between a pair of studs 151. The gate latch 111 is capable of axial rotation with respect to the connector 120 about the base region, thereby allowing the u-shaped region 115 to fit around a gate rail 132 attached to a gate 131.

Although the present invention has been described in considerable detail with reference to certain preferred versions thereof, other versions are possible. For example, the shape and material of the gate latch may vary. The u-shaped region may extend at different distances allowing accommodation for differing sizes of gates. The gate latch may also exist without a latching region. Moreover, the connector may comprise a single spring circumventing a T-post, or a plurality of springs. Therefore, the spirit and scope of the appended claims should not be limited to the descriptions of the preferred versions herein.

What is claimed is:

1. A gate keeper for attachment of a gate latch to a T-post of the type having a plurality of studs arranged along an outer surface of the T-post comprising:
a. a gate latch constructed of a rigid length of material bent such that said gate latch has a base region, an extending region, and a u-shaped region;
b. a connector circumposing said T-post;
c. wherein said base region, and said extending region extend coplanar in a first plane;
d. wherein said base region extends approximately perpendicular to said extending region;
e. wherein u-shaped region extends in a second plane;
f. wherein said extending region extends approximately perpendicular to said u-shaped region;
g. wherein said connector is removably captured between said studs of said T-post;
h. wherein said connector is fastened to said gate latch such that said base region rests against said outer surface of said T-post between said studs of said T-post;
i. wherein said gate latch axially rotates with respect to said connector about said base region, thereby causing said u-shaped region to secure a gate rail attached to a movable gate.

2. The gate keeper of claim 1, wherein said connector comprises a spring assembly.

3. The gate keeper of claim 2, wherein said spring assembly is attached to base region, and extends around said T-post.

4. The gate keeper of claim 3, wherein said spring assembly comprises a first and second spring.

5. The gate keeper of claim 4, wherein one end of said first and second spring attaches to said base region, and an opposing end of said first and second spring attaches to each other.

6. The gate keeper of claim 3, wherein the height of said connector relative to the ground can be adjusted by decompression of the spring assembly, thereby allowing movement of the connector between differing pairs of said studs attached to said T-post.

7. The gate keeper of claim 1, wherein said connector further comprises a latching region.

8. The gate keeper of claim 7, wherein said latching region extends in said first plane approximately perpendicular to said base region.

9. The gate keeper of claim 1, wherein said connector is a bracket member circumventing said T-post.

10. The gate keeper of claim 9, wherein said bracket member is a square shaped bracket piece.

11. The gate keeper of claim 9, wherein said bracket member has a pair of external apertures.

12. The gate keeper of claim 11, wherein said gate latch is inserted through said pair of external apertures securing said connector between a pair of studs attached to said T-post.

13. The gate keeper of claim 12, wherein said gate latch is capable of axial rotation with respect to said bracket member about said base region, thereby allowing said u-shaped region to fit around said gate rail attached to said gate.

14. A gate keeper comprising:
a. a T-post comprising a plurality of studs extending longitudinally along an outer surface of said T-post;
b. a gate comprising a gate rail;
c. a gate latch constructed of a rigid length of material bent such that said gate latch has a latching region, a base region, an extending region, and a u-shaped region;
d. a connector circumposing said T-post;
e. wherein said latching region, said base region, and said extending region extend in a first plane;
f. wherein said latching region extends approximately perpendicular to said base region;
g. wherein said base region extends approximately perpendicular to said extending region;
h. wherein said extending region extends approximately perpendicular to said u-shaped region;
i. wherein said u-shaped region extends in a second plane;
j. wherein u-shaped region has a curvilinear surface extending into a lengthwise surface, said lengthwise surface extending approximately parallel with said extending region at a distance which approximately greater than a diameter of said gate rail;
k. wherein said connector is removably captured between said studs of said T-post;
l. wherein said connector is fastened to said gate latch such that said base region rests against said outer surface of said T-post between said studs of said T-post;
m. wherein said gate latch axially rotates about said base region, thereby causing said u-shaped region to secure said gate rail attached to said gate.

15. The gate keeper of claim 14, wherein said connector comprises a spring assembly.

16. The gate keeper of claim 15, wherein said spring assembly is attached to base region, and extends around said T-post.

17. The gate keeper of claim 16, wherein said spring assembly comprises a first and second spring.

18. The gate keeper of claim 17, wherein one end of said first and second spring attaches to said base region, and an opposing end of said first and second spring attaches to each other.

19. The gate keeper of claim 16, wherein the height of said connector relative to the ground can be adjusted by decompression of the spring assembly, thereby allowing movement of the connector between differing pairs of said studs attached to said T-post.

20. A gate keeper comprising:
a. a T-post comprising a plurality of studs extending longitudinally along an outer surface of said T-post;
b. a gate comprising a gate rail;
c. a gate latch constructed of a rigid length of material bent such that said gate latch has a latching region, a base region, an extending region, and a u-shaped region;
d. a connector circumposing said T-post;
e. wherein said latching region, said base region, and said extending region extend in a first plane;
f. wherein said latching region extends approximately perpendicular to said base region;
g. wherein said base region extends approximately perpendicular to said extending region;
h. wherein said extending region extends approximately perpendicular to said u-shaped region;
i. wherein said u-shaped region extends in a second plane;
j. wherein u-shaped region has a curvilinear surface extending into a lengthwise surface, said lengthwise surface extending approximately parallel with said extending region at a distance which approximately greater than a diameter of said gate rail;
k. wherein said connector is removably captured between said studs of said T-post;
l. wherein said connector is fastened to said gate latch such that said base region rests against said outer surface of said T-post between said studs of said T-post;
m. wherein said connector comprises at least one spring member circumventing said T-post, said at least one spring member attached to said base region; and
n. wherein said gate latch axially rotates about said base region, thereby causing said u-shaped region to secure said gate rail attached to said gate.
